(19) United States
(12) Patent Application Publication
(10) Pub. No.: US 2016/0180375 A1
(43) Pub. Date: Jun. 23, 2016

(54) System And Method To Estimate The Incrementality Delivered By Online Campaigns Based On Measuring Impression-Level Digital Display Ad Viewability

(71) Applicants: Lochlan H. Rose, Highland Park, IL (US); Maria de las Nieves Herranz, Westmont, IL (US); Steven J. Nowlan, South Barrington, IL (US); Michael Ray Schumacher, Thousand Oaks, CA (US)

(72) Inventors: Lochlan H. Rose, Highland Park, IL (US); Maria de las Nieves Herranz, Westmont, IL (US); Steven J. Nowlan, South Barrington, IL (US); Michael Ray Schumacher, Thousand Oaks, CA (US)

(21) Appl. No.: 14/579,672

(22) Filed: Dec. 22, 2014

(51) Int. Cl. G06Q 30/02

(52) U.S. Cl. CPC G06Q 30/0244

(57) ABSTRACT

The system and method for providing a calculating the incremental value of an online advertising campaign. The incrementality is generated measuring the viewability for every impression delivered during a digital display advertising campaign, or for a representative sample of impressions and comparing a performance measure (e.g., a conversion rate) between viewable and non-viewable impressions to provide a direct measurement of the incremental effect (i.e. the value) of the viewable impression(s) so as to automatically value the online advertising campaign thereby.

### FIELD OF INVENTION

The present invention relates to a system and process for providing an automatic tool for the improved feedback for calculating the incremental value in an online advertising campaign. More specifically, the invention relates to a system and method for measuring the viewability for every impression delivered during a digital display advertising campaign, or for a representative sample of impressions and comparing a performance measure (e.g., a conversion rate) between viewable and non-viewable impressions to provide a direct measurement of the incremental effect (i.e. the value) of the viewable impression(s).

### BACKGROUND OF THE INVENTION

Measuring the effectiveness of an online advertising campaign creates a number of challenges. Historically, online advertisers have paid publishers and digital media companies using a variety of metrics (payment per impression served, payment per click, etc.) which do not provide feedback as to the real value that the online campaign provides to an overall marketing effort. That is, an advertiser that pays for an online advertising campaign cannot, without more information, obtain any feedback as to whether users who see online advertisements are more likely to make purchases or take other actions as a result of viewing the online advertisement (as opposed. e.g., to customers who would have made purchases or taken the desired activity in any event). This is especially a problem in cases where the desired action does not amount to a sale, per se, but rather involves a different form of conversion, which can vary from advertising campaign to advertising campaign and site to site. Examples of such conversions include sales of products, membership registrations, newsletter subscriptions, software downloads, or just about any activity beyond simple page browsing. More recently, some advertisers have recognized the value of “viewability” as a metric for measuring the success of an online advertising campaign. Such metrics look to shift the payment paradigm from the number of ads served to the number of “viewable impressions,” e.g., the number of impressions that are at least 50% visible to a human for a duration of at least 1 second.

However, existing metrics do not attempt to isolate the value of “viewability” separate from other reasons. Rather, such recent developments are focused upon an attempt to maximize the viewability of a given advertisement on the assumption that an increase in viewability will drive an increase in conversion. However that may be, such an approach does not back out other factors which may, in fact, be driving conversion, e.g., existing customer brand loyalty, conversion through other media placement or channels, etc. Moreover, focus of existing online advertising efforts make no attempt to quantify the value from different online advertisements or campaigns—rather, such existing approaches to viewability make the (incorrect) assumption that the level of increase in viewability will be an equally positive influence on any online advertising campaign.

Thus, the present state of the art reflects a need for a system and method which provides a measuring and valuation tool for determining the incremental value of an online advertising campaign based upon data related to the viewability of the advertisement.

### DESCRIPTION OF THE PRIOR ART

Those of skill in the art understand that viewability is a metric that can be used to value an advertising campaign. Indeed, those of skill in the art understand that a number of tools exist to measure viewability.

A first such tool is known as a “geometric” methodology for measuring viewability. The geometric approach uses Java script to retrieve coordinates from the browser to assess the browser view point (i.e. the area of the window that the user can see) as well as the position of an ad to determine if it is in view.

Another such tool is the “browser painting” methodology. The browser painting methodology relies on browser resource usage to determine if an ad is in view. The browser's rendering engine spikes as it works to show or “paint” the creative ad. According to some, this approach is uniquely able to measure whether an ad impression is viewable across all major desktop browsers, and to do so without exploiting unpatched vulnerabilities or violating user privacy.

The limitation of these existing approaches, however, is that they do not attempt to determine the incremental value that a digital campaign delivers on behalf of an advertiser, i.e., the increase in performance, financial or otherwise, that is attributable solely to the campaign. Rather, such approaches simply make a blanket assumption that viewability maintains a direct and constant relationship with the value of the creative or the campaign. Put another way, viewability is only one factor contributing to ad value. Other factors include, for example: context, geography of where the ad is served, audience, availability of other advertising channels, impact of the advertising creative presented to the user, the user's responsiveness to advertising, etc.

In sum, none of these prior art approaches permit an advertiser to determine the incremental value of each delivered advertisement or an entire advertising campaign.

What is needed is a solution which best approximates the incremental value of a given advertisement or advertising campaign by comparing the frequency of purchase or other desired action by a customer in the absence of exposure to such an advertisement or campaign.

### DEFINITION OF TERMS

The following terms are used in the claims of the patent as filed and are intended to have their broadest plain and ordinary meaning consistent with the requirements of the law.

“Viewability” means whether a digital display ad was actually displayed in such a way that a user could have viewed it for a given time period.

“Incrementality” means the incremental value that a digital campaign delivers on behalf of an advertiser, i.e. the increase in performance, financial or otherwise, that is attributable solely to the campaign.

Where alternative meanings are possible, the broadest meaning is intended. All words used in the claims set forth below are intended to be used in the normal, customary usage of grammar and the English language.

### OBJECTS AND SUMMARY OF THE INVENTION

The apparatus and method of the present invention generally includes a system and method for measuring and automatically valuing the incrementality of an online advertising campaign. Specifically, the invention includes logging information corresponding to both: i) viewable renderings of online advertisements to end users; and ii) non-viewable renderings of online advertisements to end users. Such data related to the viewable renderings of online advertisements to end users and data related to the non-viewable renderings of online advertisements to end users are analyzed to derive at least one incremental viewability value therefrom. Next, the incremental viewability value is used to alter the mixture of advertisements used in the online advertising campaign (e.g., the payload).

Thus it can be seen that one object of the present invention is to estimate the total effect of a viewable impression.

A further object of the present invention is estimating the incremental effect of a viewable impression using viewable impressions as the “test” treatment and non-viewable impressions as the “control” treatment.

Still a further object of the present invention is to provide a system and method for estimating the effectiveness of an online advertising campaign that controls for user reachability.

Yet another object of the present invention is to provide a system and method for estimating the effectiveness of an online advertising campaign that controls for the publisher visitation patterns of end users, and the conversion truncation effect.

Another object of the present invention is to provide a system and method for estimating the incremental effectiveness of an online advertising campaign according to many different criteria, including conversion rate, conversion value, clicks, signups, test drives, app downloads, solicited telephone calls, site visits, and store visits.

Still another object of the present invention is to calculate the incrementality per viewable impression.

Yet a further object of the present invention is to use incrementality estimation to optimize campaign performance.

Another object of the present invention is to estimate incrementality for all factors determining campaign performance, including publishers, end users, ad formats, ad sizes, time since user site visit, time since user was last observed online, time since last impression.

A further object of the present invention is to optimize bidding and campaign delivery based both on predicted viewability and on predicted incrementality of viewable impression (e.g., bidding in proportion to predicted viewability and predicted incrementality of impression).

Yet another object of the present invention is to identify and target end users who have greatest responsiveness to digital advertising, i.e. for whom the incrementality per impression is greatest.

It should be noted that not every embodiment of the claimed invention will accomplish each of the objects of the invention set forth above. In addition, further objects of the invention will become apparent based on the summary of the invention, the detailed description of preferred embodiments, and as illustrated in the accompanying drawings. Such objects, features, and advantages of the present invention will become more apparent in light of the following detailed description of a best mode embodiment thereof, and as illustrated in the accompanying drawings.

### BRIEF DESCRIPTION OF THE DRAWINGS

FIG. 1 shows a flowchart practicing a method in accord with a first preferred embodiment of the present invention.

FIG. 2 shows an example chart measuring the probability of conversion as a function of the number of viewable impressions in accord with the method of a preferred embodiment of the present invention.

FIG. 3 shows a three dimensional graph of a family of measurements of incrementality created in accord with a preferred embodiment of the present invention.

### DETAILED DESCRIPTION OF THE INVENTION

Set forth below is a description of what is currently believed to be the preferred embodiment or best examples of the invention claimed. Future and present alternatives and modifications to this preferred embodiment are contemplated. Any alternatives or modifications which make insubstantial changes in function, in purpose, in structure or in result are intended to be covered by the claims in this patent.

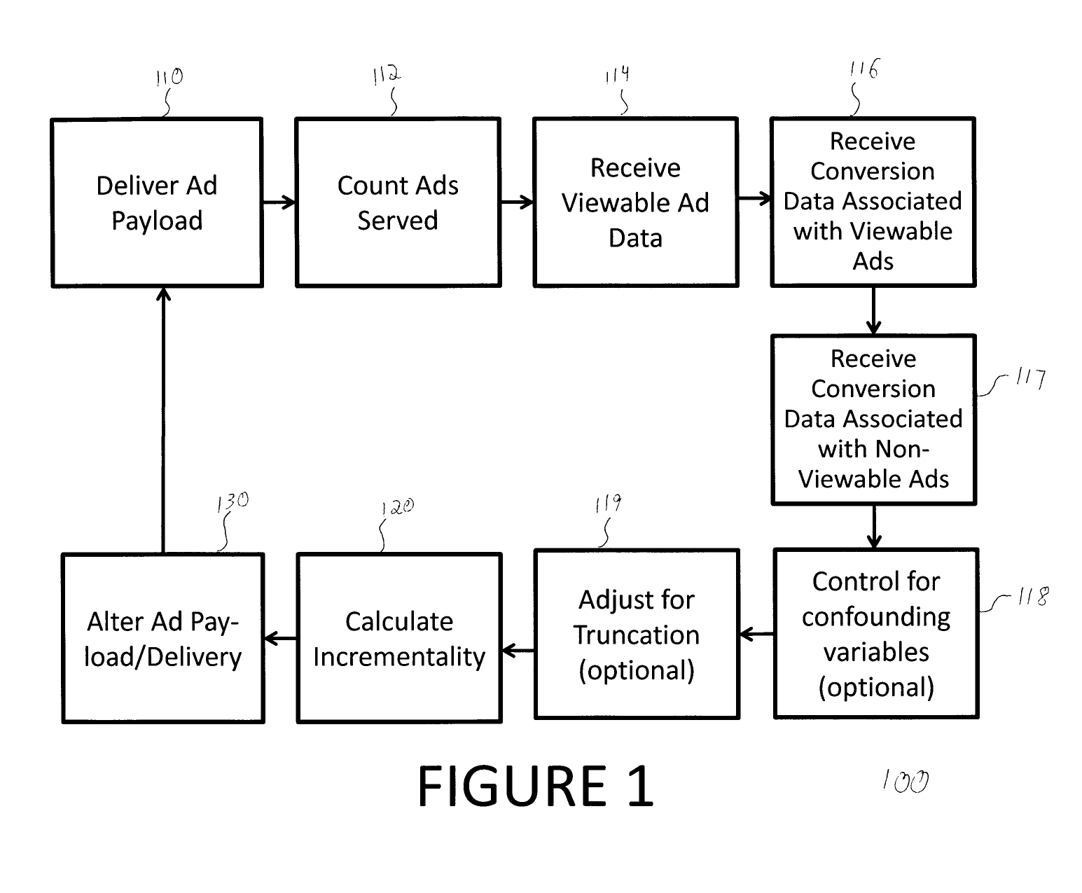

FIG. 1 shows a flowchart 100 practicing a method in accord with a first preferred embodiment of the present invention. This embodiment of the process involves a first step 110 of delivering an advertising payload to various end users over the internet, as is well known in the art. This step will include either content or a reference to content (such as a URL—uniform resource locator) to be rendered on the end user's device. Also included within this step will be delivery of a measurement payload, which contains a piece of relocatable executable computer code (such as a browser script) and which is capable of running on the end user's device and making measurements on the rendered content to determine using one of a variety of methods if that content would be visible to the end user, and how long that content remains visible to the end user. Further, this step will include a mechanism (detailed below) for sending an informational response back to the server that delivered the payload or to a separate server which can be accessed by the party that delivered the payload or a third party, such information indicating if the advertising content payload was rendered (an impression), and if the content was visible for long enough while it was rendered (a viewable impression). It should be noted in this preferred embodiment that the measurement payload may be supplied by the same party that supplies the advertising content, or it may be supplied by a third party who acts as an independent measurement authority, or the advertising payload may contain multiple measurement payloads owned by multiple parties.

Adjunct to the initiation of the process is the step 112 of measuring or counting the number of impressions served or delivered (i.e., the total number of advertisements served, whether viewable or not). Such a step may be performed on the server which delivers the advertising payload in the first instance, or it may be tallied and analyzed on a separate server containing an analytical database for calculating incrementality, i.e., through an ID or tag associated with the given served advertisement. The analytical database, however, must also perform the step 114 of receiving information from the end users about the number of viewable advertisements connected with the advertising campaign, also through an ID or tag associated with the given served advertisement using geometric, browser painting or other methodologies as known by those of ordinary skill in the art. The analytical database further performs the steps, 116 and 117 of receiving information about the conversion rate of the users associated with the viewed and non-viewed advertisements. With this information as an input, the analytical database can then perform the step 120 of calculating the incremental value of the advertising campaign. A simple example of that calculation follows:

In this example, users in Group A and in Group B are both served one impression from a digital display campaign.
The analytical database receives information that the impression delivered to each of the 5000 end users in Group A was viewable
The impression delivered to each of the 5000 end users in Group B was not viewable
The conversion counts for end users associated with the viewable and non-viewable impressions are, respectively, 52 and 50.

Using these inputs, the analytical database compare the performance measure, e.g. conversion rate, to arrive at an incrementality value of 0.04% as follows:

TABLE 1

| | | Viewable | Number | Number | |
|---|---|---|---|---|---|
| User | Impressions | Imps | of | of | Conversion |
| Group | per user | per user | Users | Conversions | Rate |
| A | 1 | 1 | 5,000 | 52 | 1.04% |
| B | 1 | 0 | 5,000 | 50 | 1.00% |
| | | | | Difference | 0.04% |

In this example, users who have seen the impression convert at a higher rate, which can be attributed to the effect of the impression. Thus, incrementality of digital display media has been calculated through the use of data surrounding viewable and non-viewable impressions.

The incrementality value thus calculated can used in the further step 130 of altering the payload or delivery of advertisements. For instance, the analytic database can be preprogrammed to increase the bid for placing advertisements when the incrementality exceeds a predetermined threshold, or a given impression may be limited or eliminated when the incrementality associated with such an impression falls below a preselected incrementality floor.

A simple business example can explain how the payload of a given online advertising campaign can be altered based upon the incremental viewability value. Assume, first, that the cost of impressions for an advertiser is $5.00 per 1000 impressions, or $0.005 per impression. We further assume, using the calculation above, that the incrementality or value of the impression is 0.04% of the value of conversion. If we assume that the average conversion value is worth $100, then value of impression is 0.04%*$100=$0.04. The calculated return on advertising spend (ROAS) is therefore $0.04/$0.005=8.0. Thus, in this example, each $1 spent on digital display media generates $8 in sales for the advertiser. The analytic database can be preloaded with predetermined set point which provides an output to control in step 130 the amount of additional delivery and the advertising payload delivered to various end users over the internet. For example, using the example above, the database can include a preselected value to pull a given advertisement when its incrementality value falls below 0.01%. Of course, those of skill in the art will appreciate that other controls, too, are possible, e.g., adjusting the advertiser's cost per impression as a function of the incrementality value.

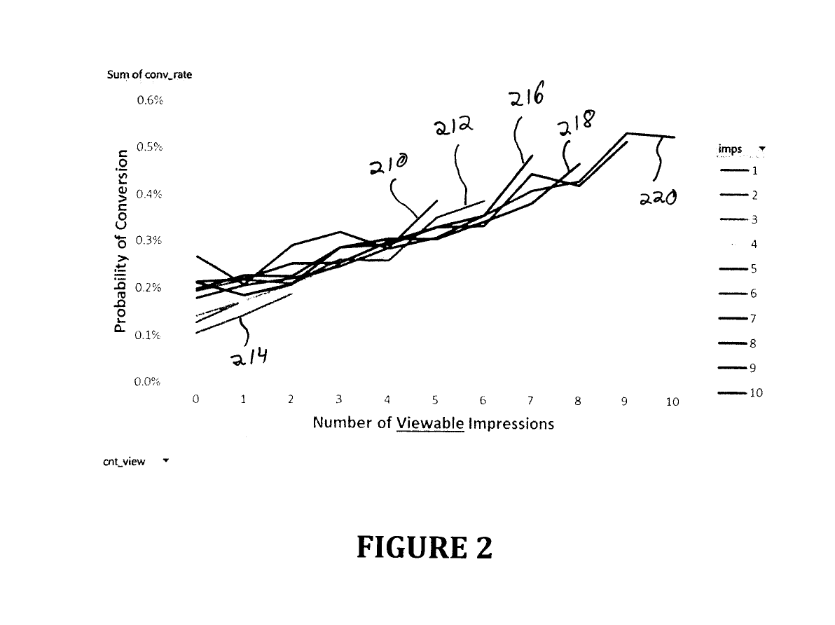

As shown in the graph of FIG. 2, those of skill in the art will understand that there is more than one possible way for the analytical database to perform the step 120 of calculating incrementality in accordance with the present invention, though all are based on the same underlying invention of using non-viewable impressions as a control. The example of the alternative embodiment is believed to be more accurate in adjusting for the effects of campaign optimization and cookie longevity.

Specifically, the chart of FIG. 2 is based on results 200 that break users into groups 210, 212, 214, 216, 218 and 220 according to how many total impressions they received. Each line in the chart represents a different group. For example, the group 214 at the bottom left of FIG. 2 represents the users who received exactly 2 total impressions. While all of the users in each group receive the same number of total impressions, different users in the group receive different numbers of viewable impressions. For example, users in group 214 could have received 0, 1, or 2 viewable impressions, so there are 3 data points on the 214 line. The number of viewable impressions is plotted on the X axis.

The vertical axis represents the average probability of conversion for users in each group. All of the lines slope upwards, which shows that each additional viewable impression increases the probability of conversion, just as one of ordinary skill in the art would expect. In this figure, based on the slope of the lines, it turns out that each additional viewable impression increases the probability of conversion by 0.033%. That is the estimated incrementality value or incremental viewability value for this particular campaign. It can be used in the same calculation described in the “Sample Business Calculation” above, replacing the value of 0.04% used in that example.

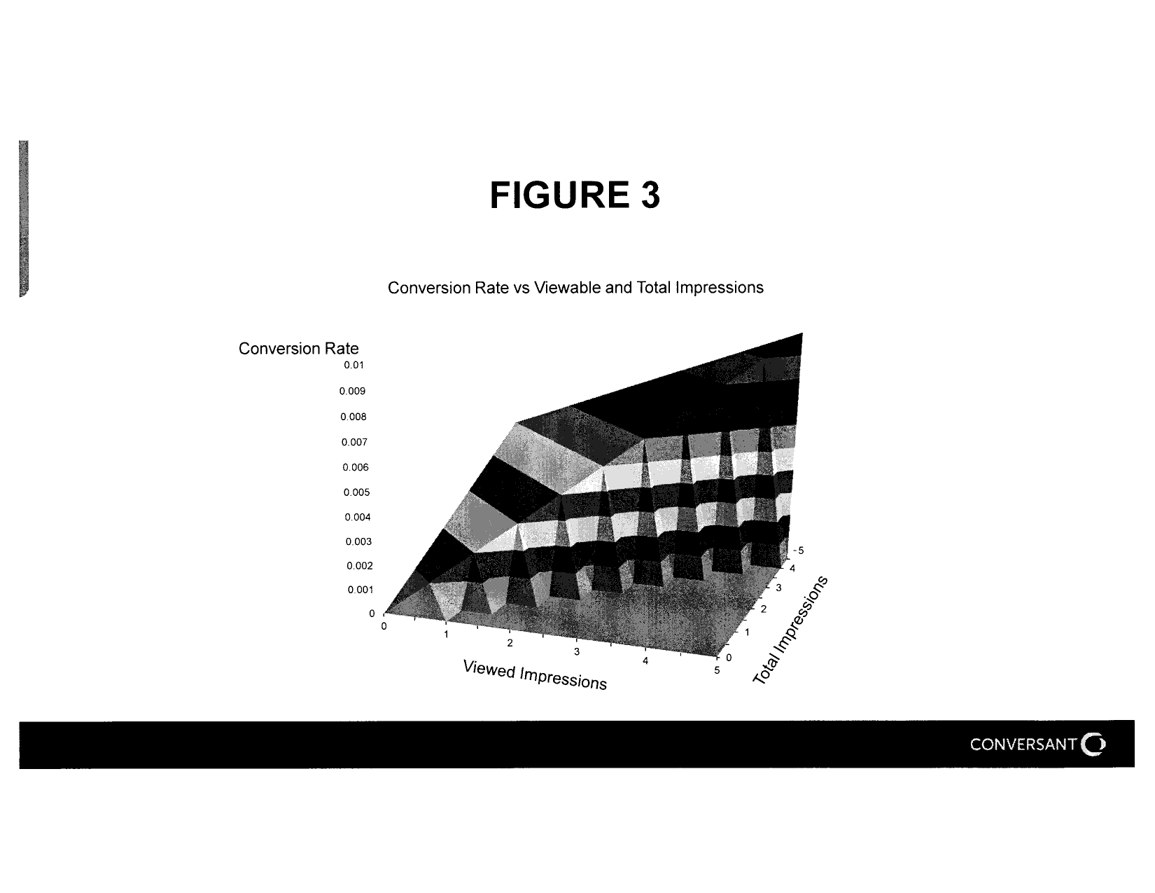

In addition to the method described in FIG. 2, an alternative way of representing and measuring incrementality of viewable impressions is illustrated in FIG. 3. In FIG. 3 a 3 dimensional surface is constructed based on a table of data which is constructed in the analytic database. Each entry in the table represents a measurement computed based on a particular combination of viewed and non-viewed impressions. An example of such a table is shown in TABLE 2:

TABLE 2

| | 0 | 1 | 2 | 3 | 4 | 5 |
|---|---|---|---|---|---|---|
| 0 | 0 | 0 | 0 | 0 | 0 | 0 |
| 1 | 0.001 | 0.002 | 0 | 0 | 0 | 0 |
| 2 | 0.002 | 0.003 | 0.004 | 0 | 0 | 0 |
| 3 | 0.003 | 0.004 | 0.005 | 0.006 | 0 | 0 |
| 4 | 0.004 | 0.005 | 0.006 | 0.007 | 0.008 | 0 |
| 5 | 0.005 | 0.006 | 0.007 | 0.008 | 0.009 | 0.01 |

In this particular example, each row represents a particular number of total impressions where total impressions is the sum of viewable plus non-viewable impressions. Each column in TABLE 2 represents a particular number of viewed impressions. Each entry in this table is computed from data based on a number of measurements of the viewability or non-viewability of a sequence of impressions. Consider for example the entry in row 3, column 2 with value 0.005. Any impression which was measured as viewable is labelled as V and any impression which was measured as not viewable with label N. Further, an impression sequence in this embodiment is defined to be a sequence of impressions shown to the same user identifier (cookie, device_id, IP_address, platform_id, and combinations). Since we are interested in a measurement in row 3 of TABLE 2, we are interested in measurements from all impression sequences of length 3. Given multiple (i.e. 100) measurements of each impression sequence, and the data can be summarized as:

| Impression Sequence | Count | Avg. Conversion Rate |
|---|---|---|
| VVN | 100 | 0.004 |
| VNV | 100 | 0.005 |
| NVV | 100 | 0.006 |

Thus, there are 3 different impression sequences, all have a length of 3, and all have exactly 2 viewable impressions within the sequence. This is how one can define all of the data points which are included in TABLE 2, entry in row 3, column 2—row number is total sequence length which is the same as the total number of impressions and column is number of viewable impressions in the sequence. For TABLE 2 each table entry is the average of the value measurements (in this case the value is avg. conversion rate), so the value of entry (3,2) in TABLE 1 is the average of the data summarized above, or in this case 0.005.

A wide variety of embodiments can be enabled by varying the nature of the function that combines measurements in each cell of the impression sequence table (i.e., sum, average, median, etc.) and also by varying the exact measurement which is combined into an impression sequence table. If the goal is to use incrementality to measure the business value of viewed impressions, the measurement will typically be related to sales transactions that can be correlated or attributed to a particular impression sequence. Typically this would be done by first tying a transaction to a customer through some type of customer identifier, and then tying the impression sequence to the same customer within a certain time window, usually by using a combination of time stamps and the user identifier that is tied to an impression sequence, as described above.

Conversion rate, the measure used in TABLE 2, is defined for that example over a population of users as the number of users who complete a sales transaction within a specified period divided by the total number of users in the population (conversion, in other embodiments, might not consider a sales transaction to be the operative conversion event). So a value of 0.005 indicates that in a population of 1000 users, 5 of them make a transaction within the defined time period. The conversion rate does not depend on the value of the transaction, but the related average conversion value does. Total conversion value can be obtained by using a sum instead of average function within the impression sequence table.

As shown in FIG. 3, the analytical database can derive a family of different measures of incrementality from the impression sequence table TABLE 2. We can see that the surface defined by the measurements within an impression sequence table is a triangular surface in three dimensional space that is sloped with respect to both the total impressions and the viewed impressions axes. The slope of the line along the total impressions axis represents a measure of incrementality due to all factors that are a function of the number of impressions, except for viewability (the data for this line corresponds to the values in the first column of TABLE 2). The slope of the deepest edge of the surface in FIG. 3 represents a measure of incrementality due only to the number of viewable impressions (in this case the incrementality of viewable impressions for all impression sequences of length 5). The data for this line corresponds to the data in the last row of TABLE 2.

Thus, by creating a data structure using the method to construct TABLE 2, so as to provide a way to measure incrementality based on viewability, the database can take the differences between pairs of entries across a row in that table and average them together to reduce any noise in the input measurements. This process is identical to the process of computing an incrementality measure as described in FIG. 2. In fact, the set of lines in FIG. 2 would be a set of lines parallel to the viewed impressions axis in FIG. 3, one line for each number of total impressions.

One major issue with measuring incrementality based on viewability is the problem of sampling noise in a sparsely distributed set of data samples. Again considering TABLE 2 as an example, while the row corresponding to 5 total impressions has 6 measurements and 5 slope samples to average across, the row corresponding to 1 total impression has only 2 measurements and one slope sample. This clearly makes the measurement of the slope very sensitive to any noise in an individual measurement. Thus, in a most preferred embodiment, it would be desirable to find a way to eliminate or reduce any noise in our measurements.

A well known approach to reducing noise in a measured quantity is to take a large number of samples all of which should have the same value, apart from the effects of noise, and average across those samples. In FIG. 3 we are showing a set of data samples constructed with no noise, and thus it is easy to see that the top or bottom surface of each shaded region represents a set of samples all of which should represent the same value. Thus, any sample drawn from this region should preferably represent multiple measurements with the same value and can be averaged across to reduce noise. Therefore, it may be desirable to build a variety of preferred embodiments simply by defining different sampling regions, as long as the sampling region is parallel to the plane defined by the x and y axis in FIG. 3.

In another preferred embodiment, the sampling region for computing an impression sequence table is defined as a range of sequence lengths, as illustrated in TABLE 3:

TABLE 3

Total viewed

| | 0 | 1 | 2 | 3 | 4 |
|---|---|---|---|---|---|
| 0 | 0 | 0 | 0 | 0 | 0 |
| 1 | 0.0135 | 0.0174 | 0 | 0 | 0 |
| “2-4” | 0.0162 | 0.0178 | 0.0194 | 0.021 | 0.0226 |
| “5-15” | 0.0237 | 0.0261 | 0.0285 | 0.0309 | 0.0333 |

In TABLE 3, the row labeled “1” corresponds to sequences of length 1, which will contain either 0 or 1 viewed impressions. The row labeled “2-4” corresponds to impressions sequence of length 2, 3 or 4, which can contain anywhere from 0 to 4 viewed impressions. This method of data structure construction corresponds to averaging along a line parallel to the “Total Impressions” axis in FIG. 3. As with TABLE 2, a direct measure of incrementality due to the number of viewable impressions for impression sequences of a particular length, or range of lengths, can be determined by the analytical database by comparing the difference between adjacent pairs of values in a row of TABLE 3, and average those differences across a row. In TABLE 3, the incrementality of a viewable impression for all impression sequences of length 2 to 4 is 0.0016, which is the average of the pairwise differences across that row of TABLE 3.

Still a further variant can be applied to the preferred embodiments which have been described thus far. The calculation of incrementality by the analytical database by using pairs of differences between adjacent entries in a row of a sequence table such as TABLE 2, or TABLE 3 implicitly assumes that all measurements are of equal value, and are based on the same number of underlying measurements. By using a controlled process for generating impression sequences that was designed just to measure viewable incrementality, this would be a reasonable assumption. However, in reality, sample measurements are from a real ad campaign which was run for some marketing objective, and the various measurements in the sequence table may be based on very different numbers of sample measurements. An improved embodiment can be built by accounting for this difference in the number of samples underlying each sequence table entry. In general, for most random or pseudo-random sampling methods, the accuracy of a measurement increases with the number of samples used to determine the measurement. Thus the estimate of viewable incrementality can be improved by using a weighted average of slope measurements, where each measurement is weighted proportionally to how many samples support the slope measurement. In that regard, while various preferred embodiments described herein make use of some type of averaging to reduce noise in estimating the incrementality, The term average in the description may refer to a simple numeric average, or to any statistical method used to estimate average properties of a set of samples including weighted and unweighted numerical averages, robust mean methods, median methods, etc. In addition, the embodiments can also be enhanced by various methods to detect and remove or discount spurious or outlier data points.

Other alternative embodiments or variants of the present invention are likewise encompassed within its scope, including those approaches which relax or modulate the assumption that the number of impressions received act as a control to measure the incremental efficacy of the advertising campaign. Amongst such alternatives are embodiments which account for confounding variables and frequency caps.

In referring to confounding variables, it will be understood that there exists another potential source of error in the estimation of the incrementality rate: confounding. Confounding variables are attributes which are correlated with an outcome measure (e.g. a conversion rate, a click-thru rate, etc.) but are potentially not observed at the same rate within two or more groups. As a result of confounding, comparisons made between two (or more) groups may not measure the incremental impact of the studied treatment (i.e. viewable impression) but instead measure the impact of the confounded variables. Such potential confounding variables include, but are not limited to, the following:
Demographic attributes such as estimated income, age, gender, and household composition;
Digital content consumption habits, including frequency and temporal proximity (i.e. last observed date) of activity by online publisher as observed through bid request logs or other means;
Previous advertiser engagement data, including previous purchase rates, amounts, estimated lifetime value, and site interaction history; and
Others (e.g. geographic location, device type, inferred interests, etc.).
   The present invention can include multiple optional techniques to control for such confounding variables. Stratification is a statistical technique to divide data into smaller cohorts with respect to chosen attribute(s) to isolate the effect of a certain treatment. For example, assume the “viewable” and “non-viewable” cohorts of an online advertising campaign have different age breakdowns as set forth in Table 4:

TABLE 4

Age Distribution

| Age | Non-Viewable Group | Viewable Group |
|---|---|---|
| 18-34 | 30% | 50% |
| 35-49 | 20% | 10% |
| 50-69 | 20% | 10% |
| 69+ | 30% | 30% |
| Total | 100% | 100% |

A basic comparison of outcome measures between the groups could be considered confounded by age, as it would be unclear if a difference in outcome measures should be credited to the treatment (viewable impressions), age, a combination of both, or potentially some other confounding variable(s).

The analytical database of the present invention can reduce or eliminate error due to such confounding variables. By taking the further step 118 of stratifying the population into mutually exclusive and collectively exhaustive strata by age, a practitioner can complete outcome measure comparisons within each stratum to control for age. As shown in Table 5, below, the aggregate baseline conversion comparison (as shown in Table 1) is misleading because the results vary by age. The originally stated difference of 0.04% could be revised to 0.21% (a weighted average of the ‘difference’ column from FIG. 3 using the “Viewable Group” weights from FIG. 2.) The method of computing a single incremental rate across strata could vary.

TABLE 5

| | Conversion Rate by Age | | |
|---|---|---|---|
| Age | Non-Viewable Group | Viewable Group | Difference |
| 18-34 | 0.57% | 0.90% | 0.34% |
| 35-49 | 1.40% | 1.45% | 0.05% |
| 50-69 | 1.40% | 1.45% | 0.05% |
| 69+ | 0.90% | 1.00% | 0.10% |
| Total | 1.00% | 1.04% | |

In practice, an exploratory data analysis could be used to select attributes for stratification, potentially through an ANCOVA or other statistical technique. As a result, the stratification scheme could result in combinations of attributes, such as age and gender, etc. However, after completing an exploratory data analysis of the “Non-Viewable” and “Viewable” groups, it is possible that many confounding variables are identified, the confounding variables are not easily stratified (e.g. continuous data), or sample sizes prohibit reliable estimates of effects. A common technique to address this is stratification through modeling.

In stratification through modeling, the analytic database performs a regression operation (a logistic regression model in present example, due to the dichotomous outcome) which is constructed to predict the likelihood of belonging to the treated class (e.g., the “Viewable” group). Each user is then scored on their likelihood to have been in the treated group, based on the aforementioned confounding variables such as age, estimated income, etc. Finally, users are then stratified as above but in accordance with the modeled score presented in this example, typically into 10 strata.

TABLE 6

Count of Unique Users

| Model Strata | Non-Viewable Group | Viewable Group |
|---|---|---|
| 1 | n1 | n11 |
| 2 | n2 | n12 |
| 3 | n3 | n13 |
| 4 | n4 | n14 |
| 5 | n5 | n15 |
| 6 | n6 | n16 |
| 7 | n7 | n17 |
| 8 | n8 | n18 |
| 9 | n9 | n19 |
| 10 | n10 | n20 |

After this stratification is complete, comparisons in the outcome measure can be made by the analytical database within strata as previously mentioned.

A second exemplar variant on the step 120 of calculating the incremental value of the advertising campaign is to adjust for truncation. That is, it is a common practice to stop delivering ads to an individual once the desired outcome or conversion (purchase, click through, site visit, sign-up, etc.) is obtained since there is no further need to influence the individual's behavior. This introduces censoring into the sequence of messages received by converters. For instance, assume that in the simple approach to the present invention as shown in Table 1 a converter would normally receive six impressions as part of an online advertising campaign. However, if the individual converted after having received only three impressions, the messaging timeline would be truncated. That is, this individual would receive only 3 impressions instead of 6, since messaging would be stopped after conversion. The individuals that convert, therefore, receive a lower number of impressions than would be expected given their characteristics at the beginning of the campaign. This leads to the counterintuitive effect of conversion rates being higher for groups that have received fewer impressions and violates the assumption of the homogeneity of the group of units that have received the same number of impressions and can lead to biased results.

The analytical database, however, can employ several techniques to control for this bias by taking the further step 119 of adjusting for truncation error. One preferred embodiment for the analytic database to perform this step is through a modification of the Heckman correction or Heckit model. Heckman's correction is a two stage method to account for selection bias. In the first stage, the probability of receiving the treatment is estimated via a logit or probit model. In the second stage, the effect of the treatment is modeled and the probabilities of receiving the treatment derived from the first stage are incorporated into the model.

### EXAMPLE

As an example, let us assume that individuals can receive one or two impressions. Individuals that receive one impression have an average conversion probability prior to messaging of c % and the individuals that receive two impressions have a probability of conversion of d %. Each impression viewed increases the probability of conversion by i %, i.e the incremental effect is i. If messaged during the whole period N10 people would receive one non viewable impressions, N11 people would receive one viewable impressions, N20 people would receive two nonviewable impressions, N21 people would receive two impressions of which one is viewable and N22 people would receive two viewable impressions.

If the messaging in this example did not stop in the event of a conversion, then the measurement of incrementality based on the group of people that received one impression would be:

(c+i)N11/N11−cN10/N10=i

However, there is a possibility that the people that should receive two impressions convert after the first one and therefore receive only one impression given that messaging is stopped after a conversion is observed. This probability of truncation is proportional to the probability of conversion, so the higher the probability of conversion, the more probable this scenario becomes. The present invention assumes that the probability of truncation is t% of the probability of conversion. This means that of the people that should have received two non-viewable impressions t*d*N20 will receive only one, and of the people that should have received one viewable and one non-viewable impressions t*(d+i)*N21 receive only one. These individuals would then be grouped with those receiving only one impression and the new measurement of incrementality would be:

((c+i)N11+t*(d+i)N21)/(N11+t*(d+i)N21)−(c*N10+t*d*N20)/(N10+t*d*N20)

which in general will be different from i, so the incrementality measurement would be biased.

By taking the further optional step 119 of adjusting for truncation error, the analytic database would assign individuals to different groups not according to the actual number of impressions they received, but according to the number of impressions they would have received in the absence of truncation.

In the first part of the optional step 119, the analytic database reassigns the converters to their correct bucket. One of the possibilities is to use a multinomial ordered logit or a tobit model in the case of large number of impressions per unit built on the uncensored observations to model the number of total and viewable impressions received. Without being exhaustive the following variables can be used to build the model: number of bid requests received, sites browsed, daily surfing patterns, cookie age, average cost of the media for sites browsed, viewability rates of the sites browsed. This model is then used to predict the number of total and viewable impressions that converters would have received had messaging not been stopped when the conversion was received.

In the second stage of the optional step 119, the analytic database would simulate new values of the total and viewable impressions for the converters using the model built in stage one. These new impressions are then used in place of the actual ones and the basic embodiment of the measurement of incrementality via viewability is used. In particular, the present example case would obtain (c+i)N11/N11−cN10/N10=I, which produces an unbiased measure of incrementality.

The above description is not intended to limit the meaning of the words used in the following claims that define the invention. Rather, it is contemplated that future modifications in structure, function or result will exist that are not substantial changes and that all such insubstantial changes in what is claimed are intended to be covered by the claims. For instance, the specific steps used in the examples of the preferred embodiments of present invention are for illustrative purposes with reference to the example drawings only. Similarly, while the preferred embodiments of the present invention are focused upon the automated pricing of campaigns using a value of incrementality, those of skill in the art will understand that the invention has equal applicability to advertising intelligence to provide feedback and automated adjustment of advertising campaigns through third-party measurement and auditing of campaign incrementality. Likewise, people of skill in the art will understand that the payload/content required by the present invention may be accessed and/or provided by multiple parties. The two most common cases in practice are likely to be cases where: 1) advertising content owned/supplied by party A and measurement payload owned/supplied by party B, with such approach allowing independent measurement of viewability by a party with no vested interest in the viewability of the content; and 2) advertising content owned/supplied by party A, with two measurement payloads, one owned by party A and one owned by party B. This second case is required when the objective is not only to measure incrementality performance via viewability, but also to optimize advertising content delivery in “real time”, i.e. to optimize viewability or optimize incrementality or both while an advertising campaign is running.

In a similar fashion, the server for receiving the viewability information mentioned above may be the same server as the server which supplies the advertising payload, or a second server owned by the same party as the first server, or a second server owned by a different party than the first server, or there may be multiple servers owned by different parties. The most common configurations would be: 1) A second server owned by a different party than the first server (generally the same party that owns the measurement payload); or 2) Multiple second servers, each owned by a different party (generally matching pairs of receiving server and measurement payload owned by the same party). This second approach allows for the two scenarios of independent measurement, or independent measurement combined with in campaign optimization. It will be appreciated by those skilled in the art that such various changes, additions, omissions, and modifications can be made to the illustrated embodiments without departing from the spirit of the present invention. All such modifications and changes are intended to be covered by the following claims.

We claim:

1. A system for calculating the incremental value of an online advertising campaign comprising:
a. A first server for delivering an advertising payload to a plurality of end users;
b. A second server for logging information corresponding to both: i) viewable renderings of online advertisements to end users; and ii) non-viewable renderings of online advertisements to end users; wherein the second server forwards information to the first server corresponding to at least the viewable renderings of online advertisements to end users;
c. A third server for logging conversion events and for performing an attribution process to connect conversion events to viewable and non-viewable renderings of online advertisements; and
d. An analytical database connected to the second and third servers for receiving both data related to the viewable renderings of online advertisements to end users and data related to the non-viewable renderings of online advertisements to end users so as to make at least one calculation of incremental value of viewable online advertisements therefrom, wherein the calculation of increment value is provided to a third party for further advertising campaign spending decisions.

2. A system for calculating the incremental value of an online advertising campaign comprising:
a. A first server for delivering an advertising payload to a plurality of end users;
b. A second server for logging information corresponding to both: i) viewable renderings of online advertisements to end users; and ii) non-viewable renderings of online advertisements to end users; wherein the second server forwards information to the first server corresponding to at least the viewable renderings of online advertisements to end users;
c. A third server for logging conversion events and for performing an attribution process to connect conversion events to viewable and non-viewable renderings of online advertisements; and
d. An analytical database connected to the second and third servers for receiving both data related to the viewable renderings of online advertisements to end users and data related to the non-viewable renderings of online advertisements to end users so as to make at least one calculation of incremental value of viewable online advertisements therefrom; wherein the analytical database instructs the server to alter advertising delivery based at least in part upon the calculation of incremental value.

3. A method for calculating the incremental value of an online advertising campaign comprising:
a. Delivering an advertising payload to a plurality of end users;
b. Receiving data from the plurality of end users corresponding to both: i) viewability renderings of online advertisements to end users; and ii) non-viewable renderings of online advertisements to end users;
c. Receiving data from the plurality of end users corresponding to conversion events and information linking each conversion event to one or more renderings of online advertisements;
d. Make at least one calculation of incremental value of viewable online advertisements using at least data corresponding to both viewable renderings of online advertisements to end users and non-viewable renderings of online advertisements to end users; and
e. Automatically altering advertising delivery based at least in part upon the incremental value of viewable online advertisements.
